(19) United States
(12) Patent Application Publication
(10) Pub. No.: US 2004/0267550 A1
(43) Pub. Date: Dec. 30, 2004

(54) Automated method for authoring and delivering product catalogs

(76) Inventors: Liang H. Hsu, West Windsor, NJ (US); Peiya Liu, East Brunswick, NJ (US); Walter Hick, Seligenporten (DE); Maurice Neligan, Erlangen (DE); Robert Greeley, Numberg (DE); Bernhard Blum, Adelsdorf (DE)

Correspondence Address: Siemens Corporation, Intellectual Property Department, 170 Wood Avenue South, Iselin, NJ, 08830, US

(21) Appl. No.: 10/603,430

(22) Filed: Jun. 25, 2003

(51) Int. Cl. G06F 17/60

(52) U.S. Cl. 705/1

(57) ABSTRACT

An automated method for authoring product catalogs includes setting up a catalog database for storing and providing data for use in the authoring of the product catalogs and authoring a product content. This includes updating a product structure, including storing new data, selecting views for a product wherein the views comprise a respective hierarchical structure of objects of various types, associating the new data with respective selected views, entering product data for the objects of various types, and updating and organizing the objects, in each case, based on the respective hierarchical structure such that the product content for all required views is stored in the catalog database.

The present invention relates to the authoring and delivering of product catalogs and, more specifically, with respect to product catalogs relating to E-business.

### BACKGROUND OF THE INVENTION

In recent years, many business activities have been moved or have at least expanded to the World Wide Web (or Web, for short) on the Internet, on intranets, and on extranets. Collectively, this activity is referred to as E-business. There are continually many thousands of organizations setting up their Web sites, and creating Web pages filled with colorful images and advanced multimedia effects to promote their respective products.

### BRIEF SUMMARY OF THE INVENTION

It is herein recognized that one of the major challenges in E-business is to integrate the Web delivery process into the in-house publishing process in an organization, so that E-business can effectively become part of the normal business of the organization, thereby providing enhanced sales and marketing benefits, rather than constituting a duplication of effort and undesirable overhead.

It is also herein recognized that in order to achieve this goal, several technical issues need to be addressed, and that an open, modularized process offers advantages. Reference is also made to the following materials: SGML ISO 8879:1986 Text and Office System-Standards Generalized Markup Language, Geneva, 1986; and XML Extensible Markup Language (XML) 1.0 (Second Edition) W3C Recommendation, 6 Oct. 2000.

In accordance with an aspect of the invention, an automated method for authoring product catalogs includes setting up a catalog database for storing and providing data for use in the authoring of the product catalogs and authoring a product content. This includes updating a product structure, including storing new data, selecting views for a product wherein the views comprise a respective hierarchical structure of objects of various types, associating the new data with respective selected views, entering product data for the objects of various types, and updating and organizing the objects, in each case, based on the respective hierarchical structure such that the product content for all required views is stored in the catalog database.

In accordance with another aspect of the invention, a publishing process for E-business is preferably implemented utilizing industrial standards such as SGML/XML and is preferably based on a modularized architecture to facilitate integration and maintenance with any existing in-house publishing process. It is herein recognized that software modules must be easily integrated, maintained, enhanced, replaced, and so forth, without affecting the overall process in any drastic way. In particular, replacing individual modules from one vendor to another, or with in-house work, must be feasible to achieve a high degree of interoperability and interchangeability.

It is an object of the present invention to provide an advanced product content publishing process which not only improves existing business activities in an organization, but also supports Web delivery for E-business applications.

The method in accordance with the invention provides unique automation techniques to optimize the publishing process, incorporates advanced document techniques to improve the quality of product content for delivery, and integrates state-of-the-art multimedia features to facilitate on-line applications

In accordance with another aspect of the invention, a database-driven approach is utilized. Most of the product data in the present application comes from the back-end engineering and manufacturing environment in an organization, and is typically stored in databases. It is herein recognized as being desirable to be able to use the product data directly from these databases to drive the E-business Web sites. Creating Web/HTML pages manually for product catalogs is impractical, and it requires extra overhead to maintain the correctness and versions of the Web/HTML files.

In accordance with another aspect of the invention, a template-based approach is utilized. To allow customization on the content and structure of product documents and catalogs without revising any software code, the users can specify their requirements in the form of XML templates or other forms of specifications. Authoring software modules must analyze the user's templates, in order to extract specific data from the product database and generate customized XML files.

Once a publishing process is established, it should be optimized to improve the efficiency of transferring data from the back-end to the Web site, and the quality of the product content delivered over the Web site. If product content is well structured, it is easy to manipulate, extract relevant information, inserting hyperlinks, etc., systematically and automatically with only a minimal amount of human intervention.

In accordance with another aspect of the invention, an advanced product content publishing process is disclosed, which not only improves existing business activities in an organization, but also supports Web delivery for E-business applications. In accordance with another aspect of the present invention, unique automation techniques are disclosed for optimizing the publishing process, incorporating advanced document techniques to improve the quality of product content for delivery, and integrating state-of-the-art multimedia features to facilitate on-line applications.

In accordance with an aspect of the invention, an automated method for authoring and delivery product catalogs, comprises the steps of: setting up a catalog database for storing and providing data for use in the authoring of the product catalogs; authoring a product content, including the steps of: updating a product structure, including storing new data, selecting views for a product wherein the views comprise a respective hierarchical structure of objects of various types, associating the new data with respective selected views, and entering product data for the objects of various types; and updating and organizing the objects, in each case, based on the respective hierarchical structure such that the product content for all required views is stored in the catalog database.

In accordance with another aspect of the invention, an automated method for authoring a product catalog, comprises the steps of: setting up a catalog database for storing and providing data for use in the authoring of the product catalogs; authoring a product content, including the steps of: generating and updating a product structure, including storing new data, selecting views for a product wherein the views comprise a respective hierarchical structure of objects of various types; associating the new data with respective selected views, entering product data for the objects of various types; updating product graphics for the objects; updating technical data for the objects; updating a related text description for the objects; and updating and organizing the objects, in each case, based on the respective hierarchical structure such that the product content for all required views is stored in the catalog database.

In accordance with another aspect of the invention, an automated method for authoring a product catalog, comprising the steps of: setting up a catalog database for storing and providing data for use in the authoring of the product catalogs; authoring a product content, including the steps of: generating and updating a product structure, including storing new data, selecting views for a product wherein the views comprise a respective hierarchical structure of objects of various types; associating the new data with respective selected views, entering product data for the objects of various types; updating product graphics for the objects; updating technical data for the objects; updating a related text description for the objects; updating and organizing the objects, in each case, based on the respective hierarchical structure such that the product content for all required views is stored in the catalog database; and publishing the catalog, including an organization of a product structure for the catalog, an organization of a product structure for the respective selected views, and an organization of a product structure of definitions, styles, and product documents for the respective selected views.

In accordance with another aspect of the invention, a system for automatically authoring a product catalog, including a programmable computer with a memory, the computer being programmed for: setting up a catalog database for storing and providing data for use in the authoring of the product catalogs; authoring a product content, including the steps of: generating and updating a product structure, including storing new data, selecting views for a product; wherein the views comprise a respective hierarchical structure of objects of various types; associating the new data with respective selected views, entering product data for the objects of various types; updating product graphics for the objects; updating technical data for the objects; updating a related text description for the objects; and updating and organizing the objects, in each case, based on the respective hierarchical structure such that the product content for all required views is stored in the catalog database.

In accordance with another aspect of the invention, a system for automatically authoring a product catalog, including a programmable computer with a memory, the computer being programmed for: setting up a catalog database for storing and providing data for use in the authoring of the product catalogs; authoring a product content by updating a product structure, including storing new data, selecting views for a product wherein the views comprise a respective hierarchical structure of objects of various types, associating the new data with respective selected views, and entering product data for the objects of various types; and updating and organizing the objects, in each case, based on the respective hierarchical structure such that the product content for all required views is stored in the catalog database.

### BRIEF DESCRIPTION OF THE SEVERAL VIEWS OF THE DRAWINGS

The invention will be more fully understood from the detailed description which follows, in conjunction with the drawings, in which

FIG. 1 shows in schematic flowchart form a product content publishing process helpful to an understanding of the principles of the invention;

FIG. 2 shows in schematic flowchart form a process of product content authoring in accordance with the principles of the invention;

FIG. 3 shows in schematic flowchart form a process of updating product graphics in accordance with the principles of the invention;

FIG. 4 shows in schematic flowchart form a process of updating technical data in accordance with the principles of the invention;

FIG. 5 shows in schematic flowchart form a process of updating text description in accordance with the principles of the invention;

FIG. 6 shows in schematic flowchart form a process of product content delivery in accordance with the principles of the invention;

FIG. 7 shows in schematic flowchart form a process of catalog generation in accordance with the principles of the invention;

FIG. 8 shows in schematic flowchart form a process of generating objects in accordance with the principles of the invention;

FIG. 9 shows in schematic flowchart form a process of generating sub-objects in accordance with the principles of the invention; and

FIG. 10 shows in schematic flowchart form a process of catalog publishing in accordance with the principles of the invention.

### DETAILED DESCRIPTION OF THE INVENTION

In overview, a method in accordance with the invention facilitates automatically authoring and delivering product catalogs. With this method, product content is organized in a well-structured way in the catalog database, and can be extracted, structured, and (optionally) transformed to support various deliveries for E-business applications. The features and aspects herein disclosed and described include the following:

A Product Content Publishing Process to support automatic (and manual) authoring and delivery of product catalogs. The publishing process comprises three steps: Product Content Authoring, Product Content Delivery, and Product Content Presentation.

The product content authoring process is built on top of the product structure with multiple views for representing different aspects of the product data. Each product view comprises a well-defined structure of document objects, based on the product content DTD. Each document object is attached with a set of properties.

A step-by-step procedure for updating product graphics is provided for updating and organizing document objects that represent product graphics. It includes procedures for generating multiple layers of images and AIUs to support viewing and navigation.

A step-by-step procedure for updating technical data is provided for updating and organizing document objects that represent technical data. It includes procedures for extracting product data from the back-end systems, and generating structured technical data.

A step-by-step procedure or updating text description is provided for updating and organizing document objects that represent text descriptions. It includes procedures for developing form-based GUI to support data entry and extracting product data from the back-end systems to generated structured text descriptions.

The product content delivery process is generally based on the concept of single-source multiple-delivery. It comprises four steps: Catalog Generation, Catalog Publishing, (optional) Catalog Conversion, and Catalog Preview.

A template-based (or specification-based) approach is provided for relating product data between the catalog database and the catalog documents. A template or specification is basically the structure of the catalog documents to be generated; it is used to control the catalog generation process.

There are two types of template objects: variables and catalog objects. Variables represent local values that are valid in the context of the catalog objects to which they belong. Catalog objects are used to extract product data from the database, so that instances of them can be generated to the target catalog documents.

There are four types of catalog objects: constant object, database query, conditional command, and external references. Constant objects are copied to the target documents directly. Database queries are evaluated, and product data is retrieved from the database. A repetition command can be attached to a database query in order to generate multiple instances of the objects, one for each data record returned from the database query. A conditional command is evaluated to decide whether to generate a catalog object. An external reference is used to generate a catalog object that refers to external files prepared with other applications.

At each level of catalog objects generated to the target catalog documents, an index list is also generated to support searching and navigation at that level.

The catalog publishing process is provided for setting up the publishing environment properly in a physical structure such as file directories or delivery database to support the delivery. It includes publishing of product structure and product views. For each product view, view definition, view styles, and all related product documents are published.

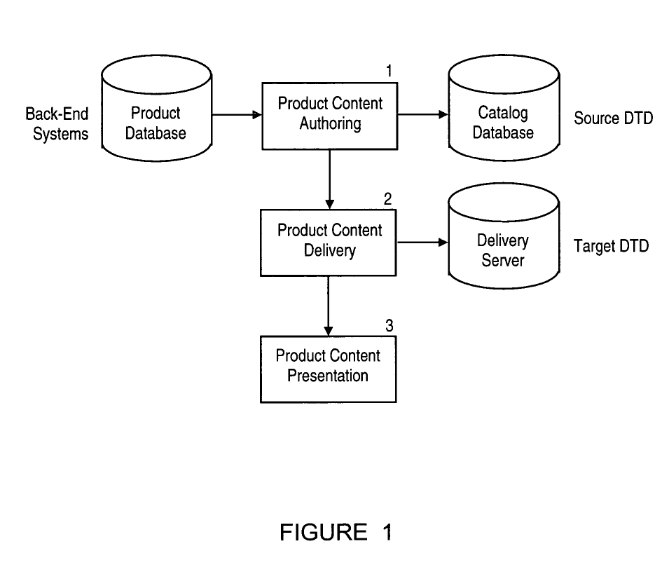

A typical product content publishing process is shown in FIG. 1. It comprises three basic steps, namely: Product Content Authoring, Product Content Delivery, and Product Content Presentation. Referring to FIG. 1, at Step 1, product data is usually prepared with a Form-Based Product Data Editor, or extracted directly from the product database in the back-end engineering and manufacturing environment. Integration of the publishing process with back-end systems has become a major undertaking in E-business applications. Created or extracted product data is stored in the catalog database, which is structured based on a standard or company-specific Document Type Definition, (DTD) referred to as Source DTD's.

Product data stored in the catalog database is well-structured to capture the relationships between different types of product data in order to support as many applications as possible. The data is represented in open, standard formats, such that no information will be lost when converting into application-specific formats for delivery. The catalog database is typically mostly accessed by internal personnel in an organization, document control is enforced in retrieving and updating the catalog data, and versions and history are maintained throughout the lifecycle of the products.

At Step 2, different types of product data are extracted from the catalog database, based on the requirements of a specific application. Product data is re-structured and configured to generate application-specific documents for delivery. Catalog documents are transferred from the catalog database to the delivery server, which is accessed by the end users and external customers. If necessary, catalog documents on the delivery server can be re-structured based on a completely different document type definition (DTD), referred to as Target DTD, especially, when participating in an E-marketplace.

At Step 3, catalog documents are attached with proper style sheets for rendering with the Web browsers. If necessary, they can also be converted into a format such as Hypertext Markup Language (HTML) for the Web browser. In particular, the publishing process must also support all business activities other than E-business. For example, many business activities still require high-quality printing versions of same/similar product content for printing and for download. In this case, catalog documents in Extensible Markup Language (XML) can be converted into a format such as Framemaker, Ventura, etc. that is more suitable for printing. Furthermore, to support maintenance and service tasks with mobile devices, catalog documents in XML may need to be converted into different structures and formats that are feasible for rendering on mobile devices with limited resources.

The process in accordance with the invention is essentially very general from the logical point of view. For example, if the product content is simple enough, one single DTD, instead of two, may be enough to meet the requirements at all steps of the process. If the amount of product content is limited, two or three steps of the process and their corresponding databases and servers may be merged into one single step with one single database and server. In addition, all steps of the process can be fulfilled with trivial applications such as text editors, or can be optimized by automated techniques. Regarding the product content, simple text descriptions and images can be used to meet the basic marketing requirements, or advanced multimedia effects can be adopted to improve the usability.

Generally, in the remainder of the present description, the first steps are described in greater detail than the third step which typically does not lend itself as readily to a significant amount of automation.

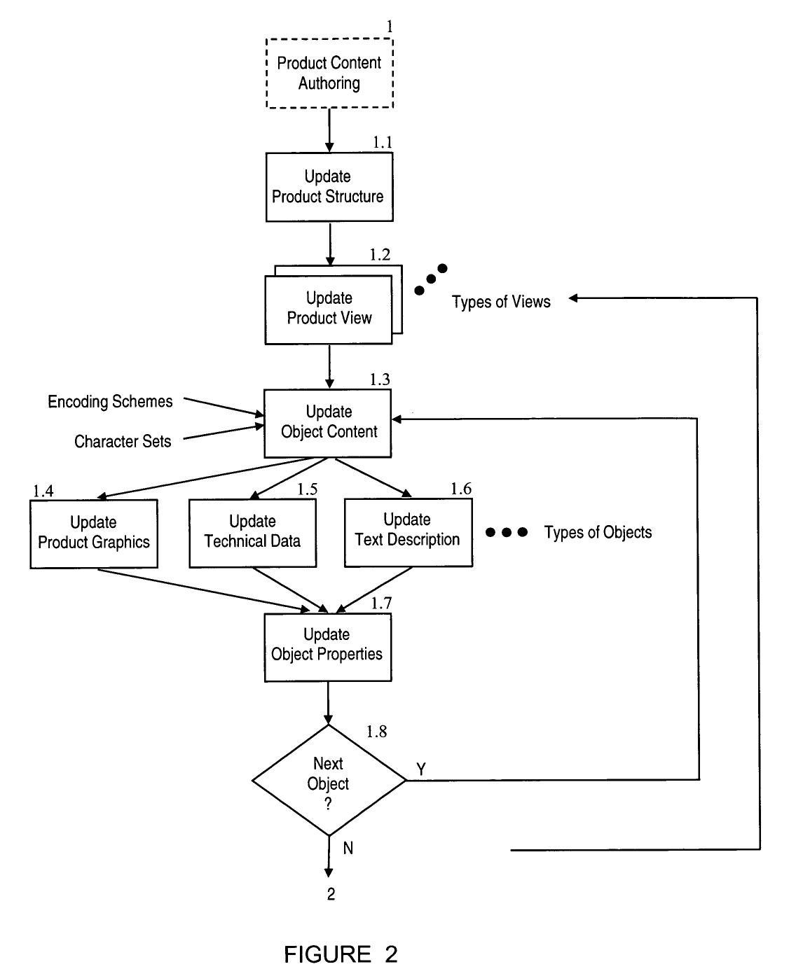

The process of authoring product content, whether created manually with a Form-Based Product Data Editor, or automatically extracted from the product database in the back-end system, involves updating product structure, product view, and content of objects in the catalog database, as shown in FIG. 2. At Step 1.1, the product structure is updated in order to incorporate the new data for a new or existing product. Typically, most products are grouped by models and organized in a hierarchical way. In accordance with a preferred embodiment of the present invention, the same type of structure is also applied to the catalog database, in order to facilitate searching and navigation in a specific delivery.

Each product is associated with multiple views of product data, e.g., product specification, schematic diagrams, configuration, product images, operating instructions, maintenance procedures, etc. At Step 1.2, a view of the product is identified for storing the new data to be entered. Each view is represented by a hierarchical structure of objects. Some views may optionally contain a fixed number of objects in a fixed structure, while others may optionally contain an indefinite number of objects in an expandable structure. The catalog database is flexible enough to accommodate both cases, and supports different applications on top of the database. The content of some product views may be extracted automatically from the back-end systems or other sources. In this case, the product content extractors must also be flexible enough to generate either fixed or expandable structures of objects to be inserted into the database.

In accordance with the principles of the invention, views can be used to model many different concepts. For example, views can be used to represent the “mode” of a task in a task-oriented approach. Typical modes in an engineering environment include operation, inspection, repair, training, etc. Product data can be entered and stored to facilitate different modes of the engineering tasks involved. Product information in different views may be cross referenced, and may be extracted and integrated in any way that is appropriate for specific applications at a later stage.

At Step 1.3, product data for each type of object in a view is entered manually or extracted automatically. Each unit of product data, e.g., a digit, a letter, a symbol, a byte, etc., is represented and interpreted based on the encoding scheme adopted for the product content and the character set to which the product data unit belongs. Sequences of product data units may represent the content of different types of objects, including product graphics, a complicated technical specification, a simple text description, etc. At Steps 1.4, 1.5, 1.6, etc., the content of different types of objects is entered, and the objects are organized based on the structure of a specific view. More details of Steps 1.4, 1.5, and 1.6 are provided further down in the present description.

At Step 1.7, a set of properties is entered and attached to an object to further qualify the type of product information represented by the object. Typical properties include, but are not limited to, Id, type, font (if necessary), color (if necessary), format (GIF, JPEG, TIF, EPS, etc.), location (of the origin), size (width and height), new frame (if necessary), new page (if necessary), etc. At Step 1.8, the authoring process continues until all objects for the specific view are completed (manually or automatically, at one time or at different times) and organized properly in the structure of the view.

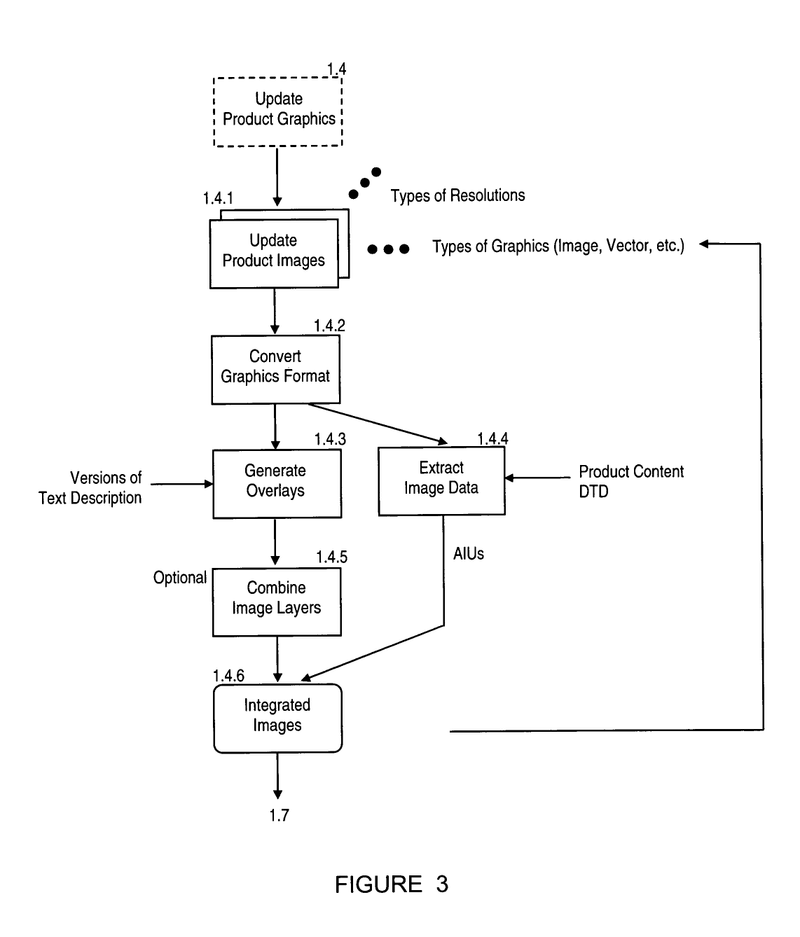

The authoring process is also repeated for all required views of a product (manually or automatically, at one time or at different times) and organized properly in the structure of the product. At the completion of the authoring process for a product, the product content of all required views of the specific product is ready in the catalog database, which can be extracted, structured and, optionally, transformed to support the delivery for various different applications. Reference is made to FIG. 3 with regard to updating product graphics. Product graphics are used in several different contexts, including, for example, an image for a product in a product catalog, as part of the overview of the product, or various product related images and diagrams that are included in the product catalogs and documents. There are several types of product graphics: images, vector graphics, 3D, animation, etc. However, in practically all cases, product graphics are typically prepared with sophisticated graphics applications, and the graphics files are incorporated in the product catalogs and documents.

At Step 1.4.1, each type of graphics with each resolution is prepared and entered into the catalog database. At Step 1.4.2, product graphics are further manipulated, including converting from one format to another, changing resolution, changing colors, the number of colors, cropping, scaling, rotating, etc., in order to integrate them properly into the catalogs and documents. The same graphics with different formats and resolutions may be needed for different applications, such as for example, thumbnail images (“thumbnails”) of product images being needed as icons in the higher-level product catalog, higher resolutions of the same images may be needed for the print version, etc.

In order to include graphics and images with artistic quality in the product catalogs and documents, at Step 1.4.3, special overlays are often added to the basic graphics and images, including mixing multiple graphics and images in a special way, providing special background, etc. Some product graphics include text labels, measurements, etc., which need to be localized for users and customers at different regions and countries. This can also be accomplished by the overlaying technique.

In an advanced product catalog, searching and navigation are supported to the level of individual objects. At Step 1.4.4, product graphics, especially, computer aided design (CAD) drawings and schematic diagrams, are processed to extract relevant Id's, labels, symbols, etc. The extracted information is referred to as Anchorable Information Units (AIU's) and is represented in a structure based on the DTD used to represent the product content in an application domain. The application that is used for the AIU extraction purpose is thus referred to as an AIU Extractor. Since the viewer or browser used to view product catalogs is usually not as sophisticated as the graphics applications, the extracted AIU information is rendered on a layer that is superimposed on top of the images to support advanced searching and navigation.

If a viewer or browser does not support overlaying, Step 1.4.5 is utilized in order to generate a single overlay of images by performing the mixing or combining the images from all layers. At

Step 1.4.6, an integrated product image is generated and stored in the catalog database; it contains all types of data related to the product graphics, which can be used in the product catalogs and documents for printing, Web delivery, etc. The process of manipulating product graphics may be repeated as many times as necessary for different combinations of formats and resolutions to prepare for different deliveries.

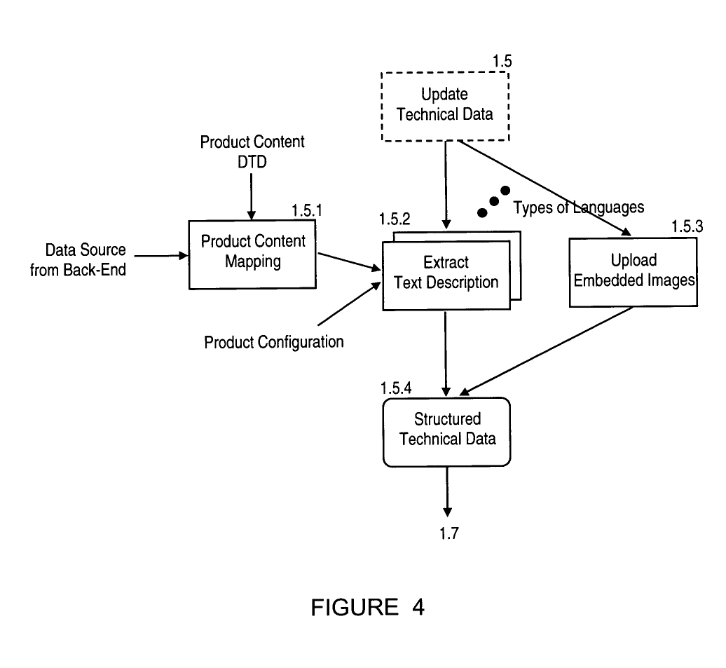

The upgrading of technical data is now considered in further detail. Technical data such as specifications also plays an important role in a product catalog. It often contains product information that is available from back-end systems such as PDM or ERP. Referring to FIG. 4, at Step 1.5.1, product content from the back-end systems is mapped into a proper format to be included into the text description. A product content DTD is also defined in order to capture the structure of the product content and facilitate the mapping process. At Step 1.5.2, all product specifications and configurations are extracted, and structures such as lists and tables are generated to organize these types of product data. Product catalogs are often available in multiple languages; thus, multiple versions of the text descriptions are also generated, one for each respective language.

Text description may contain two types of graphics: in-line graphics and embedded graphics. In-line graphics are created and rendered as separate objects in a similar way as headings and paragraphs. In accordance with a principle of the present invention, uploading in-line graphics follows the same procedure as Step 1.4. Embedded graphics are typically images such as icons for special symbols, which are embedded in running text, lists, tables, etc. At Step 1.5.3, uploading embedded objects is achieved by separating sub-objects from their parent objects in the document structure, and while traversing the document tree structure, a decision is made that all objects under a certain level (e.g., heading, paragraph, table, etc.) are considered to be sub-objects, i.e., embedded objects. Embedded objects are handled at a level under regular objects; i.e., they are specifically marked when entered by the user, or extracted with an extractor, and they are stored in the catalog database as part of the regular objects they belong to.

In order to meet specific marketing requirements, technical data with text and graphics are arranged and aligned in a complicated way. At Step 1.5.4, an object of technical data is completed by integrating all types of product data in a structure that can support the delivery of complex technical data. The object of structured technical data is stored in the catalog database, which can be extracted, structured and (optionally) transformed for different applications.

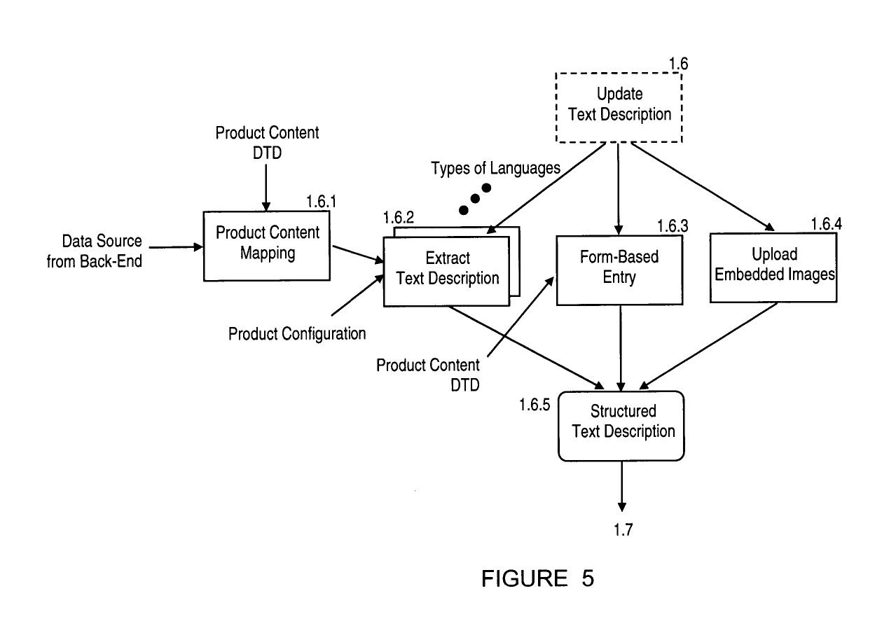

With regard to text description updating, reference is made to FIG. 5. It is noted that text descriptions include typical document objects such as headings, paragraphs, lists, nested lists, tables (smaller and simpler, compared to technical data), graphics, etc. Product graphics, embedded graphics, and tables can be handled as in Steps 1.4, 1.5.3, and 1.5. Product data that is available from the back-end systems can also be extracted in the same way as in Steps 1.5.1 and 1.5.2. However, the structure of text descriptions is often different from that of technical data, so different DTD (or different part of the same DTD) is used for mapping and extracting the content. As in technical data, multiple versions of text descriptions are also prepared to support the user and customers at different regions and countries.

In order to support the user for entering the product data manually, at Step 1.6.3, a typical Form-Based Data Editor is also provided in accordance with an aspect of the present invention. Depending on the complexity of the text descriptions, the form-based graphic user interface (GUI) can be a simple form, similar to other form-based database applications, which can be developed manually or automatically generated from a template of the product catalog. On the other hand, the form-based GUI can also be as complicated as an SGML/XML structure editor, which allows the users to create any of a number of expandable structures. In the latter case, developing or automatically generating such a form-based GUI is desirable. Merely technical issues are involved in the automatic generation of a form-based data editor to support expandable structure based on a specific DTD.

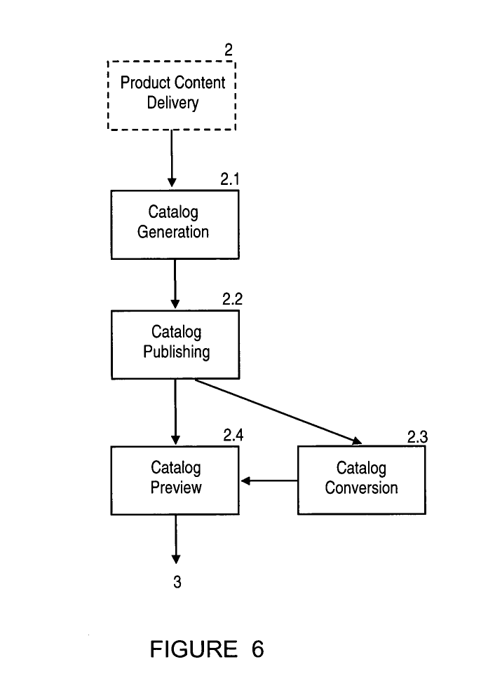

With regard to product content delivery, reference is made to FIG. 6. As stated earlier, the product content authoring process can be performed manually or automatically. During the authoring process, product data is entered and stored in a well-structured way in the catalog database to support various types of applications. The product content delivery process starts at Step 2.1, where product data is extracted based on the needs of each application, and organized in a structure that is suitable for the target application, e.g., CD, E-business Web site, high-quality printing, etc.

At Step 2.2, the generated documents together with all the required files such as external graphics files, DTD, entity definition files, style sheets, etc. are arranged in the proper file directory structure, or any other type of delivery database structure that is required by the target application, and is then delivered to the target application. At Step 2.3, an optional conversion or transformation can be applied to generate the final format for the target application, e.g., HTML for Web browser that does not support XML, a proprietary format for high-quality printing software, etc. At Step 2.4, the final result is previewed in an emulated environment for the target application, before it is actually delivered.

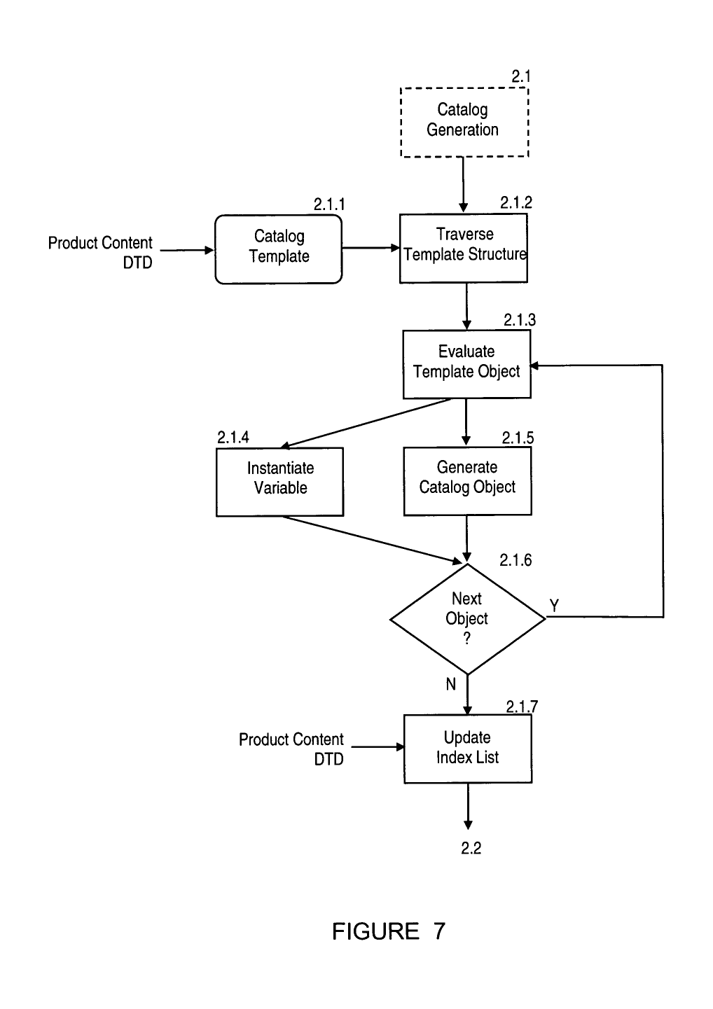

With regard to catalog generation, reference is made to FIG. 7. An important part of the delivery process is to generate the target catalog documents from the product content in the catalog database. In order to support the concept of single-source multiple-delivery, templates (or specifications) are used to specify the structures of different deliveries for different applications. At Step 2.1.1, a catalog template is created based on the DTD; it provides the typical structure of product catalog to be generated. There may be as many templates as the number of different deliveries, one for each delivery. Typically, there are catalog templates for on-line delivery and for printing. For example, for on-line delivery, objects and structures to support on-line sequential viewing are specified. On the other hand, for printing, objects and structures to support two-dimensional, multi-column layout with high-quality images are specified.

At Step 2.1.2, a catalog template is parsed and traversed, in order to analyze its structure. While traversing the template, an instance of a target catalog document is generated. In the trivial case, the target catalog document being generated may contain exact the same content as the template. In the other extreme, the template may be empty (except for global references such as catalog database, product name, etc.), and the target catalog document being generated has a complete new structure.

During the traversal process, at Step 2.1.3, each object found in the template structure is evaluated, in order to take proper actions. There are two types of template objects: variables and catalog objects. At Step 2.1.4, variables are used to store local and global values. Local values apply only in the context of a specific object, while global values apply to all objects. Typical global values, for example, are catalog database, product name, etc. In either case, a template variable can be defined and evaluated, and its value can be used in evaluating all other objects.

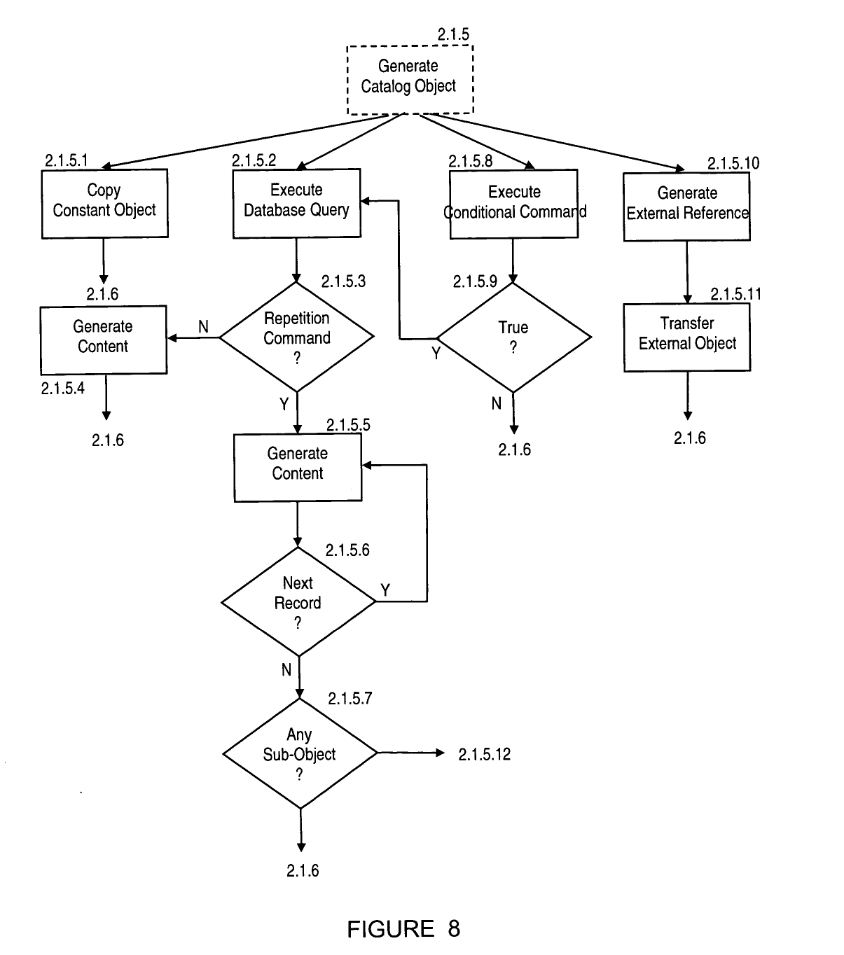

If a template object is not a variable, it is a catalog object to be evaluated, and an instance of the template object, i.e., a real catalog object, will be generated to the target catalog document. At Step 2.1.5, the content of the catalog objects is identified or extracted from the catalog database to form the catalog object to be generated. The process of generating a catalog object is shown in FIG. 8. Steps 2.1.3 to 2.1.6 repeat until all template objects are evaluated, and instances of them are generated to the target catalog documents. Global variables are typically defined at the beginning of a template, while local variables can be defined in the context of catalog objects.

To facilitate searching and navigation, at Step 2.1.7, an index list (e.g., ToC) is also generated to the catalog documents. An index list typically comprises references to high-level objects and important objects, e.g., headings of sub-documents, specification tables, product graphics, etc. An index list is also generated based on the DTD, so that structural navigation can be supported in a general way.

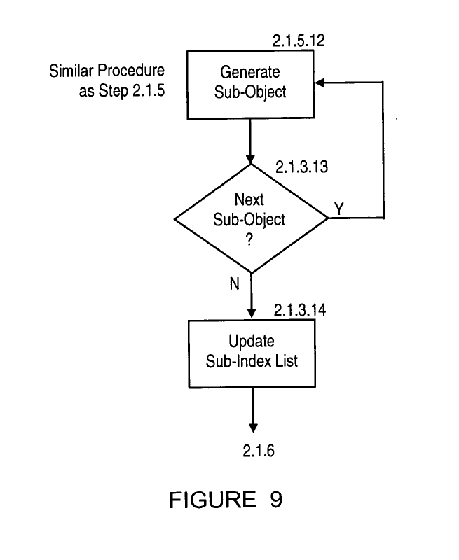

Reference is made to FIGS. 8 and 9 with regard to generating objects and sub-objects. For each catalog object specified in the template, one or more objects are generated in the target catalog document. In the simplest case, at Step 2.1.5.1, a catalog object specified in the template is a constant object, i.e., after all variables are replaced with values, the object is complete and can be copied to the target catalog document as is. Although this step is trivial, it is a very practical feature to ensure the consistency of all target documents generated from the same template. Constant objects typically contain the same “canned content” for all target documents. For example, the name of a product can be represented as a variable, which can be fixed in the template for generating all target documents with the identical product name.

At Step 2.1.5.2, a typical catalog object is specified in the template, i.e., the content of the object is specified by a database query. Typical database queries are retrieval and manipulation of contents of database table fields, which are mostly used as the content of the objects in the target documents. Since there may be multiple data records retrieved from the catalog database, it is possible to generate multiple catalog objects, one for each data record. At Step 2.1.5.3, a catalog object is checked if a repetition command is attached. If not, at Step 2.1.5.4, the content of the catalog object is generated in the target catalog document. On the other hand, if a repetition command is attached, at Steps 2.1.5.5 and 2.1.5.6, the number of records or other counter retrieved from the database table can be used to repeat the generation of the catalog object to the target documents.

A catalog object may contain sub-objects. At Step 2.1.5.7, if there are sub-objects, the process continues with generation of sub-objects.

The third type of catalog objects is a conditional command, which is evaluated with the values from local and global variables, and possibly, the product data retrieved from the catalog database. If it evaluates to False, no action is to be taken. If it evaluates to True, a database query is performed, and instances of the catalog objects are generated as described above.

The fourth type of catalog objects is external references, e.g., graphics objects, objects whose contents are prepared with other applications, etc. At Step 2.1.5.10, catalog objects with external references are generated, and at Step 2.1.5.11, the external files are transferred to the proper file directory to be incorporated into the target catalog documents.

Referring to FIG. 9, at Steps 2.1.5.12 and 2.1.5.13, sub-objects are generated in the same way as generating other objects. Sub-objects can also be constant objects, objects with database queries, or external references as described above. In addition, at Step 2.1.3.14, a sub-index list is also generated to support searching and navigation, similar to an index list.

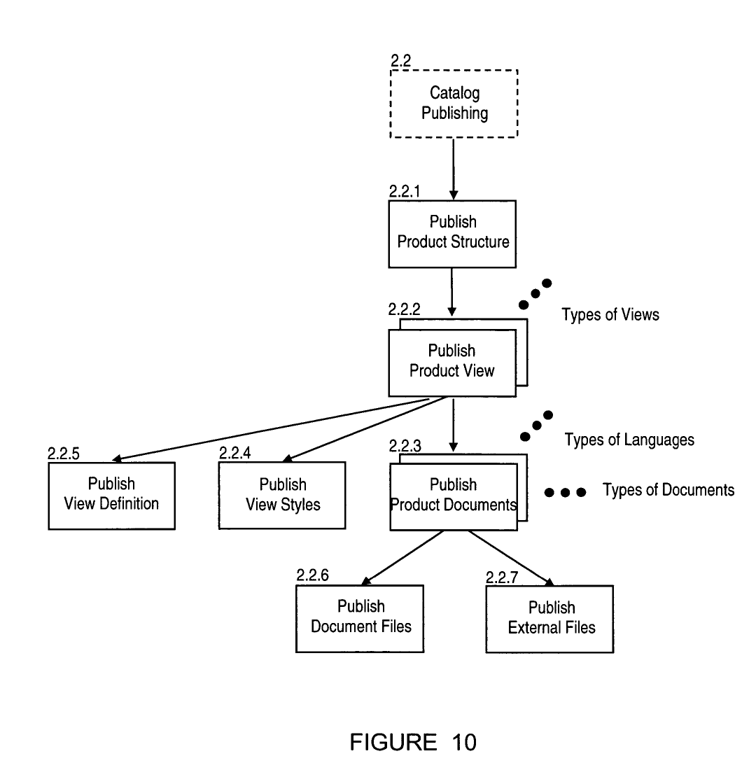

Reference is made to FIG. 10 with regard to catalog publishing. After all the needed product data is extracted, organized, and generated in the proper document structure based on the DTD for a target application, the next step is to publish them in the proper “physical” structure, i.e., file directories or delivery database, to be rendered by the target application.

At Step 2.2.1, the product structure is first published, i.e., the file directory structure (or delivery database) is initialized to represent the product structure, so that views for the product can be organized properly. At Step 2.2.2, the file directory structure (or delivery database) for various views of the product is also initialized, so that data and documents of each view can be organized properly. At Step 2.2.3, the definition of each view is published, which typically includes DTD's, entity definition files, etc. At Step 2.2.4, the styles for the view are published, which typically includes style sheets, transformation specifications, etc.

At Step 2.2.5, the product documents are published, which typically includes publishing the product documents at Step 2.2.6 together with all external files at Step 2.2.7. Product documents and external files are published for each document type for each language.

The invention has been described by way of exemplary embodiments and is best practiced with the application of a programmable digital computer. As will be understood by one of skill in the art to which the present invention pertains, various changes and modifications will be apparent. Such changes and substitutions which do not depart from the spirit of the invention are contemplated to be within the scope of the invention which is defined by the claims following.

What is claimed is:

1. An automated method for authoring and delivery product catalogs, comprising the steps of:
setting up a catalog database for storing and providing data for use in said authoring of said product catalogs;
authoring a product content, including the steps of:
updating a product structure, including storing new data,
selecting views for a product wherein said views comprise a respective
hierarchical structure of objects of various types,
associating said new data with respective selected views, and
entering product data for said objects of various types; and
updating and organizing said objects, in each case, based on said respective hierarchical structure such that said product content for all required views is stored in said catalog database.

2. An automated method for authoring and delivering product catalogs as recited in claim 1, wherein said step of updating a product structure, including storing new data, comprises the steps of:
updating product graphics for said objects;
updating technical data for said objects; and
updating a related text description for said objects.

3. An automated method for authoring and delivering product catalogs as recited in claim 2, including the steps of:
updating an encoding scheme for said objects; and
updating a character set for said objects.

4. An automated method for authoring and delivering product catalogs as recited in claim 3, including the steps of:
entering the content of said objects; and
organizing said objects based on the structure of a specific view.

5. An automated method for authoring and delivering product catalogs as recited in claim 4, including the step of:
entering a set of properties; and
attaching said set of properties to an object to further qualify the type of product information represented by the object.

6. An automated method for authoring and delivering product catalogs as recited in claim 2, wherein said step of updating product graphics for said objects comprises:
processing said product graphics in accordance with given requirements;
selectively generating and adding overlays to said product graphics; and
extracting prescribed image data from said processing of said product graphics.

7. An automated method for authoring and delivering product catalogs as recited in claim 6, wherein said step of extracting prescribed image data from said processing of said product graphics comprises extracting data including relevant ID's, labels, and symbols.

8. An automated method for authoring and delivering product catalogs as recited in claim 6, wherein said step of updating product graphics for said objects comprises:
combining said prescribed image data and said overlays so as to produce a resulting integrated image.

9. An automated method for authoring and delivering product catalogs as recited in claim 8, wherein said step of combining said prescribed image data and said overlays comprises integrating said prescribed image data for adding anchorable information units (AIU's) to said integrated image.

10. An automated method for authoring and delivering product catalogs as recited in claim 6, wherein said step of selectively generating and adding overlays comprises:
selectively combining selected ones of said overlays for providing a format suitable for given browsers and viewers

11. An automated method for authoring and delivering product catalogs as recited in claim 6, wherein said step of extracting prescribed image data from said processing of said product graphics comprises extracting data including relevant ID's, labels, and symbols.

12. An automated method for authoring and delivering product catalogs as recited in claim 2, wherein said step of updating product graphics for said objects comprises:
combining said prescribed image data and said overlays so as to produce a resulting integrated image.

13. An automated method for authoring and delivering product catalogs as recited in claim 12, wherein said step of combining said prescribed image data and said overlays comprises integrating said prescribed image data for adding anchorable information units (AIU's) to said integrated image.

14. An automated method for authoring a product catalog, comprising the steps of:
setting up a catalog database for storing and providing data for use in said authoring of said product catalogs;
authoring a product content, including the steps of:
generating and updating a product structure, including storing new data,
selecting views for a product wherein said views comprise a respective
hierarchical structure of objects of various types;
associating said new data with respective selected views,
entering product data for said objects of various types;
updating product graphics for said objects;
updating technical data for said objects;
updating a related text description for said objects; and
updating and organizing said objects, in each case, based on said respective hierarchical structure such that said product content for all required views is stored in said catalog database.

15. An automated method for authoring and delivering a product catalog as recited in claim 14, wherein said step of updating product graphics comprises:
updating and entering into said database product images;
manipulating said graphics;
extracting anchorable information units (AIU) from said graphics;
generating overlay image layers for said graphics;
optionally combining said overlay image layers; and
generating an integrated product image.

16. An automated method for authoring and delivering a product catalog as recited in claim 14, wherein said step of updating product graphics comprises:
generating a further image layer including said AIU's; and superimposing said further image layer on said overlay images.

17. An automated method for authoring and delivering a product catalog as recited in claim 14, wherein said step of updating technical data for said objects comprises:
retrieving product information data from a back-end system;
extracting a product text description containing at least one of in-line graphics and
embedded graphics;
mapping said product information data into an appropriate format for inclusion into said product text description;
uploading said embedded graphics;
integrating said embedded graphics and said product text description for forming an object of technical data; and
storing said object of technical data in said database.

18. An automated method for authoring and delivering a product catalog as recited in claim 17, wherein said step of uploading said embedded graphics comprises:
defining sub-objects from respective parent objects in said product text description in accordance with given criteria.

19. An automated method for authoring and delivering a product catalog as recited in claim 18, wherein said step of uploading said embedded graphics comprises:
storing and processing said sub-objects under said respective parent objects.

20. An automated method for authoring and delivering a product catalog as recited in claim 14, wherein said step of updating a related text description comprises:
retrieving product information data from a back-end system;
extracting a product text description containing at least one of in-line graphics and embedded graphics;
mapping said product information data into an appropriate format for inclusion into said product text description;
uploading said embedded graphics;
entering user defined product data into said database;
integrating said embedded graphics, said product text description for forming a structured text description, and said user defined product data for forming a structured text description; and
storing said structured text description in said database.

21. An automated method for authoring and delivering a product catalog as recited in claim 14, including:
generating said catalog;
publishing said catalog;
previewing said catalog;
optionally formatting said catalog; and
delivering said catalog.

22. An automated method for authoring and delivering a product catalog as recited in claim 20 including:
generating a catalog template structure in accordance with said document type definition;
parsing and traversing said catalog template structure;
evaluating, during said traversing, template objects found in said template structure as variables and catalog objects, wherein an object which is not a variable is considered a catalog object for evaluation;
generating at least one real catalog object for an instance found of a catalog object; and
identifying and extracting content from said database for generating said real catalog object for said an instance.

23. An automated method for authoring and delivering a product catalog as recited in claim 22, wherein said step of generating at least one real catalog object for an instance found of a catalog object comprises:
generating a real catalog object that is a constant object by replacing variables constituting said real catalog object by respective values thereof.

24. An automated method for authoring and delivering a product catalog as recited in claim 23, wherein said step of generating at least one real catalog object for an instance found of a catalog object comprises:
identifying a variable constituent in said real catalog object and fixing a definition for said variable constituent which comprises an external reference, whereby said external references is located and transferred to be incorporated in its target real catalog object.

25. An automated method for authoring and delivering a product catalog as recited in claim 23, wherein said step of generating at least one real catalog object for each instance found of a catalog object comprises:
identifying a variable constituent in said real catalog object and fixing a definition for said variable constituent in said template such that target documents based on said template include said definition for said variable.

26. An automated method for authoring and delivering a product catalog as recited in claim 25, wherein said step of generating at least one real catalog object for said each instance found of a catalog object comprises:
fixing said definition for said variable as a product name.

27. An automated method for authoring and delivering a product catalog as recited in claim 25, wherein said step of generating at least one real catalog object for said each instance found of a catalog object comprises:
fixing said definition for said variable as a query.

28. An automated method for authoring and delivering a product catalog as recited in claim 25, wherein said step of generating at least one real catalog object for said each instance found of a catalog object comprises:
fixing said definition for said variable as a query requiring retrieval and manipulation of data base contents.

29. An automated method for authoring and delivering a product catalog as recited in claim 25, wherein said step of generating at least one real catalog object for said each instance found of a catalog object comprises:
fixing said definition for said variable as a query requiring retrieval and manipulation of database data fields.

30. An automated method for authoring and delivering a product catalog as recited in claim 25, wherein said step of generating at least one real catalog object for said each instance found of a catalog object comprises:
fixing said definition for said variable as a conditional command, depending for execution thereof on any of said local and global variables and said data base contents.

31. An automated method for authoring and delivering a product catalog as recited in claim 25, wherein said step of generating at least one real catalog object for said each instance found of a catalog object comprises:
fixing said definition for said variable as a query so as to cause generation of multiple catalog objects resulting from multiple data records.

32. An automated method for authoring and delivering a product catalog as recited in claim 25 wherein said step of generating at least one real catalog object for said each instance found of a catalog object comprises:
fixing said definition for said variable cause generation of multiple catalog sub-objects.

33. An automated method for authoring and delivering a product catalog as recited in claim 22, wherein said step of generating at least one real catalog object for said instance found of a catalog object comprises:
generating catalog sub-objects having the attributes of said real catalog objects.

34. An automated method for authoring and delivering a product catalog as recited in claim 22, including:
defining global variables at said generating a catalog template structure; and defining local variables at said evaluating template objects.

35. An automated method for authoring and delivering a product catalog as recited in claim 22, including:
generating an index list comprising references to selected objects.

36. An automated method for authoring and delivering a product catalog as recited in claim 15, comprising:
publishing said catalog as at least one of a delivery database and a set of file directories.

37. An automated method for authoring and delivering a product catalog as recited in claim 36, comprising:
publishing an organization of a product structure for said catalog;
publishing an organization of a product structure for said respective selected views; and
publishing an organization of a product structure of definitions, styles, and product documents for said respective selected views.

38. An automated method for authoring a product catalog, comprising the steps of:
setting up a catalog database for storing and providing data for use in said authoring of said product catalogs;
authoring a product content, including the steps of:
generating and updating a product structure, including storing new data,
selecting views for a product wherein said views comprise a respective
hierarchical structure of objects of various types;
associating said new data with respective selected views,
entering product data for said objects of various types;
updating product graphics for said objects;
updating technical data for said objects;
updating a related text description for said objects;
updating and organizing said objects, in each case, based on said respective hierarchical structure such that said product content for all required views is stored in said catalog database; and
publishing said catalog, including an organization of a product structure for said catalog, an organization of a product structure for said respective selected views, and an organization of a product structure of definitions, styles, and product documents for said respective selected views.

39. A system for automatically authoring a product catalog, including a programmable computer with a memory, said computer being programmed for:
setting up a catalog database for storing and providing data for use in said authoring of said product catalogs;
authoring a product content, including the steps of:
generating and updating a product structure, including storing new data,
selecting views for a product wherein said views comprise a respective
hierarchical structure of objects of various types;
associating said new data with respective selected views,
entering product data for said objects of various types;
updating product graphics for said objects;
updating technical data for said objects;
updating a related text description for said objects; and
updating and organizing said objects, in each case, based on said respective hierarchical structure such that said product content for all required views is stored in said catalog database.

40. A system for automatically authoring a product catalog as recited in claim 39, wherein said computer is programmed for:
updating and entering into said database product images;
manipulating said graphics;
extracting anchorable information units (AIU) from said graphics;
generating overlay image layers for said graphics;
optionally combining said overlay image layers; and
generating an integrated product image.

41. A system for automatically authoring a product catalog, including a programmable computer with a memory, said computer being programmed for:
setting up a catalog database for storing and providing data for use in said authoring of said product catalogs;
authoring a product content by:
updating a product structure, including storing new data,
selecting views for a product wherein said views comprise a respective
hierarchical structure of objects of various types,
associating said new data with respective selected views, and
entering product data for said objects of various types; and
updating and organizing said objects, in each case, based on said respective hierarchical structure such that said product content for all required views is stored in said catalog database.

42. A system for automatically authoring a product catalog as recited in claim 41, wherein said computer is programmed for:
updating product graphics for said objects;
updating technical data for said objects; and
updating a related text description for said objects.
